(19) United States
(12) Patent Application Publication
(10) Pub. No.: US 2024/0410526 A1
(43) Pub. Date: Dec. 12, 2024

(54) CARBON DIOXIDE OCEAN LIQUID BALLOON STORAGE METHOD

(71) Applicant: DALIAN UNIVERSITY OF TECHNOLOGY, Dalian (CN)

(72) Inventors: Cong CHEN, Dalian (CN); Yongchen SONG, Dalian (CN); Ya YIN, Dalian (CN); Zherui CHEN, Dalian (CN); Jingyue SUN, Dalian (CN); Zhiwei LI, Dalian (CN); Linan GUAN, Dalian (CN); Yan QIN, Dalian (CN); Zheng LING, Dalian (CN); Yu LIU, Dalian (CN); Yi ZHANG, Dalian (CN)

(21) Appl. No.: 18/473,449

(22) Filed: Sep. 25, 2023

(30) Foreign Application Priority Data
May 29, 2023 (CN) 202310612458.1

(51) Int. Cl. F17C 5/02; F17C 1/00

(52) U.S. Cl. CPC F17C 5/02; F17C 1/007; F17C 2221/013; F17C 2270/0128

(57) ABSTRACT

The present invention provides a carbon dioxide ocean liquid balloon storage method. The method comprises: suspending an uncharged liquid balloon device in seawater at a depth of not less than 600 m in advance; conveying liquid carbon dioxide to an inside of the liquid balloon device through a conveying pipe; when the liquid carbon dioxide charging volume reaches the rated charging volume of a carbon dioxide submarine storage device, stopping charging; closing a stop valve of a liquid balloon inlet pipe and disconnecting the carbon dioxide conveying pipe from the liquid balloon inlet pipe; and controlling the liquid balloon device to enable the liquid balloon device to be placed in a seabed at the appropriate depth, with the depth of the seabed of not less than 3,000 m. The whole liquid balloon device is of a frame liquid balloon structure, and comprises a frame structure and a liquid balloon structure.

### TECHNICAL FIELD

The present invention belongs to the technical field of controlling greenhouse gas effect, and particularly relates to an ocean storage method for carbon dioxide.

### BACKGROUND

Due to global dependence on fossil fuels, carbon dioxide emissions generated from industrial production and human life are increasing day by day, resulting in greenhouse gases that are seriously threatening the earth's environment. Carbon storage technology captures carbon dioxide from large emission sources and stores it in a suitable place, thereby avoiding being released into the atmosphere. However, the long-term storage technology for carbon dioxide is still in a tentative research stage, especially there are still many imperfections in the safety assessment of storage. Therefore, improving the storage safety for carbon dioxide is an important research topic. Carbon dioxide storage technology generally mainly comprises two schemes such as geological storage and ocean storage. The geological storage technology means the carbon dioxide is stored using geological structures (comprising sedimentary basin deep saline aquifer, abandoned oil and natural gas fields, coal field, etc.). The ocean storage technology means the storage is achieved using ocean water body as a carrier of carbon dioxide, comprising ocean dissolution storage and submarine liquid carbon dioxide pool storage. The potential of ocean storage is huge, but the ocean dissolution storage and the submarine liquid carbon dioxide pool storage will have a great impact on the ocean environment, such as ocean acidification. In addition, the carbon dioxide stored in seawater is likely to escape from the seawater and be released into the atmosphere when it encounters temperature and pressure fluctuations or changes in ocean currents, which will cause opposite results of the carbon dioxide storage.

Therefore, in order to achieve long-term effective and stable carbon dioxide storage, it is necessary to develop an ocean carbon storage method that is simple in operation and not easy to escape carbon dioxide.

### SUMMARY

The purpose of the present invention is to provide a submarine carbon dioxide storage method which is conducive to realizing long-term effective and stable carbon dioxide storage.

The present invention has the following technical solution:
a carbon dioxide ocean liquid balloon storage method, comprising the following steps:
step 1: suspending a carbon dioxide submarine storage liquid balloon device in seawater at a depth of not less than 600 m in advance;
step 2: conveying liquid carbon dioxide to an inside of the liquid balloon device through a conveying pipe; when the liquid carbon dioxide charging volume reaches the rated charging volume of the liquid balloon device, stopping charging;
step 3: closing a stop valve of a liquid balloon inlet pipe and disconnecting the carbon dioxide conveying pipe from the liquid balloon inlet pipe; and controlling the liquid balloon device to enable the liquid balloon device to be placed in a seabed at the appropriate depth.

The liquid balloon device is of a frame liquid balloon structure, and comprises a frame structure and a liquid balloon structure,
wherein the frame structure comprises a frame structure main body and a connecting device. The frame structure main body is a large grid rigid frame, which is used for protecting an internal liquid balloon structure in the process of carbon dioxide submarine storage; the material of the frame structure main body can be concrete, cast iron, etc., and the shape can be square, spherical and preferably spherical; the connecting device is connected with the frame structure main body, and is used for connecting with a ship and other surface platforms by steel cables, iron chains, etc., to control the suspension and lifting of the liquid balloon device;
the liquid balloon structure is used for storing the liquid carbon dioxide, and the liquid balloon structure is connected with the frame structure main body and is arranged in the rigid frame structure main body; the liquid balloon structure is of flexible material such as rubber and plastic; and a liquid balloon inlet pipe and a stop valve are arranged at an inlet of the liquid balloon structure, wherein the liquid balloon inlet pipe is connected with the liquid carbon dioxide conveying pipe through the stop valve and is used for charging the liquid carbon dioxide into the liquid balloon structure, and the stop valve is used for controlling the storage of the liquid carbon dioxide after the charging of the liquid carbon dioxide. Before filling with liquid carbon dioxide, there is no filling inside the liquid balloon structure (2), and the liquid balloon structure (2) is in the contracted state; after filling with liquid carbon dioxide, the liquid balloon structure (2) is in an inflated state, and at this moment, the shape and size of the liquid balloon are matched with that of the frame structure main body.

An outer side of the liquid balloon structure is in direct contact with seawater. In seawater at a depth of not less than 600 m, carbon dioxide will remain liquid when being charged into the liquid balloon structure. The structure of the liquid balloon is flexible and an outer surface of the liquid balloon structure is in direct contact with the seawater, so as to ensure that internal and external pressure differences of the liquid balloon structure are only used to overcome elastic contraction force of the liquid balloon structure and do not change with the depth of the seawater when the carbon dioxide is stored in the seabed, and the liquid balloon structure will not be damaged due to excessive seawater pressure.

The overall density of the liquid balloon device is greater than that of sea water, and the overall device has negative buoyancy in sea water. The relaxation speed of the suspended steel cable is controlled, the suspended liquid balloon device is placed in the seabed at the appropriate depth, and the connecting device on the surface of the frame structure is disconnected to retract the steel cable.

Further, the submarine depth is not less than 3,000 m, at this depth, the density of the liquid carbon dioxide is greater than that of surrounding seawater, and the liquid balloon device can be stable in the seabed.

Further, the liquid carbon dioxide is conveyed to the liquid balloon structure through the liquid carbon dioxide conveying pipe and the liquid balloon inlet pipe in the following ways: the liquid carbon dioxide from the surface platform is charged into the liquid carbon dioxide conveying pipe through a metering pump, and the liquid carbon dioxide enters the liquid balloon structure through the conveying pipe and the liquid balloon inlet pipe.

On the basis of the above technical solution, the present invention can also be improved as follows.

Further, a ring retaining structure is pre-placed in the seabed; after the liquid balloon device is placed in the ring retaining structure, the frame structure of the liquid balloon device is opened; the liquid balloon structure is discharged into the ring retaining structure; and the frame structure is retracted and reused under the action of steel cables.

The shape of the ring retaining structure is similar to a large open chamber, and can be a fence, a wall and other structures for protecting and fixing the liquid balloon structure.

The technical solution of the present invention has the following beneficial effects:
1. the technical solution provided in the present invention can safely and effectively realize massive storage and long-term sequestration for submarine carbon dioxide;
2. in the technical solution provided in the present invention, the carbon dioxide is not in direct contact with the seawater, the risk of leakage is low, and the impact on an ocean environment is minimal, in short, so that the carbon dioxide storage has high efficiency;
3. the requirements for the device are low, and the operation steps are simple and easy to implement; the liquid carbon dioxide is charged when the carbon dioxide submarine storage device is suspended in the seawater at a depth of 600 m, and the charging pressure of the liquid carbon dioxide is low, which has low requirements for the metering pump and the liquid carbon dioxide conveying pipe. the liquid balloon is of flexible material, and the pressure difference between inside and outside the liquid balloon is only used to overcome the elastic contraction force of the liquid balloon and does not change with the seawater depth; and the liquid balloon will not be damaged due to excessive seawater pressure, and the pressure bearing requirement for the liquid balloon is low; and
4. the carbon dioxide stored in the submarine liquid balloon device can be recycled when needed.

### DESCRIPTION OF DRAWINGS

FIG. 1 is a flow diagram of a carbon dioxide ocean storage method provided in one embodiment of the present invention.

FIG. 2 is a structural schematic diagram of a liquid balloon device used in one embodiment of the present invention.

FIG. 3 is a carbon dioxide storage system used in one embodiment of the present invention.

### REFERENCE NUMERALS

1 frame structure main body; 2 liquid balloon structure; 3 connecting device; 4 liquid balloon inlet pipe; 5 stop valve; 6 liquid balloon device; 7 offshore platform; 8 metering pump; 9 liquid carbon dioxide conveying pipe; 10 steel cable retractor; and 11 steel cable.

### DETAILED DESCRIPTION

The present invention provides the following optimized embodiments.

### Embodiment 1

As shown in FIG. 1, one embodiment of the present invention provides a carbon dioxide submarine storage method, comprising:
step 1: suspending a carbon dioxide submarine storage liquid balloon device 6 in seawater at a depth of not less than 600 m in advance;
step 2: conveying liquid carbon dioxide to an inside of the liquid balloon device 6 through a conveying pipe 9; when the liquid carbon dioxide charging volume reaches the rated charging volume of the liquid balloon device 6, stopping charging;
step 3: closing a stop valve 5 of a liquid balloon inlet pipe and disconnecting the carbon dioxide conveying pipe 9 from the liquid balloon inlet pipe 4; and controlling the liquid balloon device 6 to enable the liquid balloon device to be placed in a seabed at the appropriate depth.

### Embodiment 2

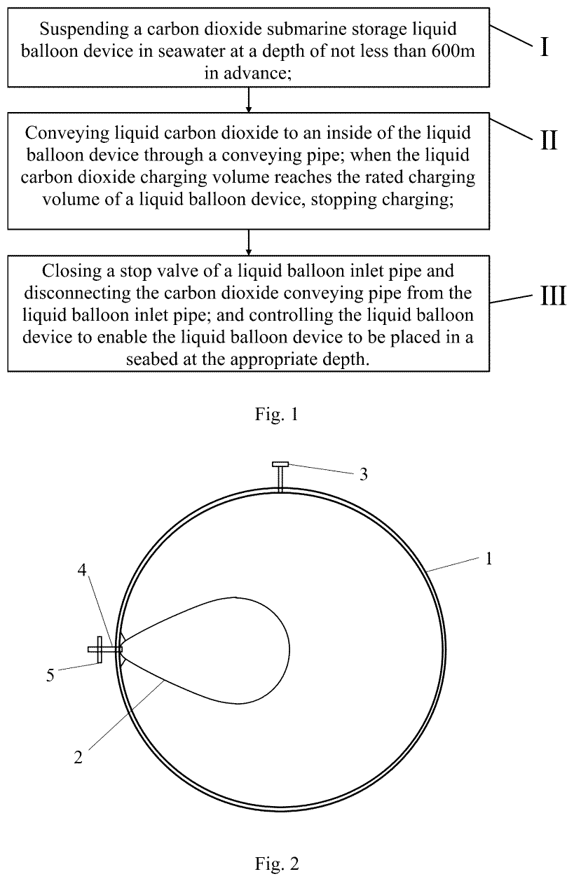

One embodiment of the present invention provides a carbon dioxide submarine storage liquid balloon device 6. As shown in FIG. 2, the device has a frame liquid balloon structure, and comprises a frame structure and a liquid balloon structure:
the frame structure comprises a frame structure main body 1 and a connecting device 3. The frame structure main body 1 is a large grid rigid frame, which is used for protecting an internal liquid balloon structure 2 in the process of carbon dioxide submarine storage; the material of the frame structure main body 1 can be concrete, cast iron, etc., and the shape can be square, spherical and preferably spherical; the connecting device 3 is connected with the frame structure main body 1, and is used for connecting with a ship and other surface platforms by steel cables, iron chains, etc., to control the suspension and lifting of the liquid balloon device 6;
the liquid balloon structure 2 is used for storing the liquid carbon dioxide, and the liquid balloon structure 2 is connected with the frame structure main body 1 and is arranged in the rigid frame structure main body 1; the liquid balloon structure 2 is of flexible material such as rubber and plastic; and a liquid balloon inlet pipe 4 and a stop valve 5 are arranged at an inlet of the liquid balloon structure 2, wherein the liquid balloon inlet pipe 4 is connected with the liquid carbon dioxide conveying pipe 9 through the stop valve 5 and is used for charging the liquid carbon dioxide into the liquid balloon structure 2, and the stop valve 5 is used for controlling the storage of the liquid carbon dioxide after the charging of the liquid carbon dioxide. the charged liquid carbon dioxide fore-liquid structure 2 has no filling material inside, and the liquid balloon structure 2 presents a contraction state; and the charged liquid carbon dioxide post-liquid structure 2 presents a charging structure, and at this moment, the shape and size of the liquid balloon 2 are matched with that of the frame structure main body 1.

An outer side of the liquid balloon structure 2 is in direct contact with seawater. In seawater at a depth of not less than 600 m, the carbon dioxide will remain liquid when being charged into the liquid balloon structure 2; and the structure of the liquid balloon 2 is flexible and an outer surface of the liquid balloon structure 2 is in direct contact with the seawater, so as to ensure that internal and external pressure differences of the liquid balloon structure 2 are only used to overcome elastic contraction force of the liquid balloon structure 2 and do not change with the depth of the seawater when the carbon dioxide is stored in the seabed, and the liquid balloon structure 2 will not be damaged due to excessive seawater pressure.

The overall density of the liquid balloon device 6 is greater than that of sea water, and the overall device has negative buoyancy in sea water. The relaxation speed of the suspended steel cable 11 is controlled, the suspended liquid balloon device 6 is placed in the seabed at the appropriate depth, and the connecting device 3 on the surface of the frame structure is disconnected to retract the steel cable.

### Embodiment 3

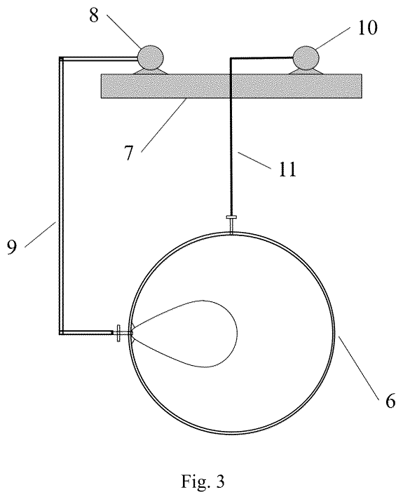

In an optional example of the present invention, a carbon dioxide storage device and method therefore are carried out using a carbon dioxide storage system as shown in FIG. 3. The carbon dioxide storage system comprises a liquid balloon device 6, an offshore platform 7, a metering pump 8, a liquid carbon dioxide conveying pipe 9, a steel cable retractor 9, and a steel cable 11 in carbon dioxide storage;
the specific storage process is achieved in the following ways:
the liquid carbon dioxide that needs to be stored is conveyed to a storage site through the offshore platform 7;
on the offshore platform 7, the liquid balloon device 6 is suspended in seawater at a depth of not less than 600 m through the steel cable retractor 10 and steel cable 11; the metering pump 8, the liquid carbon dioxide conveying pipe 9 and the liquid balloon inlet pipe 4 on the carbon dioxide submarine storage liquid balloon device 6 are connected, and the stop valve 5 is opened;
the metering pump 8 is started, and the liquid carbon dioxide is charged into liquid balloon device 6 through the liquid carbon dioxide conveying pipe 9 and liquid balloon inlet pipe 4, and when the liquid carbon dioxide charging volume reaches the rated charging volume of the carbon dioxide submarine storage device, the charging stops;
the stop valve 5 is closed, and the liquid carbon dioxide conveying pipe 9 is disconnected from the liquid balloon liquid inlet pipe 4; the liquid balloon device 6 is slowly placed at the seabed through the steel cable retractor 10 and the steel cable 11, and then the connecting device 3 on the liquid balloon device 6 is disconnected to retract the steel cable; and preferably, the submarine depth is not less than 3,000 m.

In order to reduce the cost of carbon dioxide storage, for a near-shore carbon dioxide storage area, submarine pipeline transportation can be used instead of the offshore platform 7 to charge the liquid carbon dioxide that needs to be stored to the liquid balloon device 6.

1. A carbon dioxide ocean liquid balloon storage method, comprising the following steps:
step 1: suspending a carbon dioxide submarine storage liquid balloon device (6) in seawater at a depth of not less than 600 m in advance;
step 2: conveying liquid carbon dioxide to an inside of the liquid balloon device (6) through a conveying pipe; when the liquid carbon dioxide charging volume reaches the rated charging volume of the liquid balloon device (6), stopping charging;
step 3: closing a stop valve (5) of a liquid balloon inlet pipe and disconnecting the carbon dioxide conveying pipe from the liquid balloon inlet pipe (4); and controlling the liquid balloon device (6) to enable the liquid balloon device to be placed in a seabed,
wherein the liquid balloon device (6) has a frame liquid balloon structure, and comprises a frame structure and a liquid balloon structure (2);
the frame structure comprises a frame structure main body (1) and a connecting device (3); the frame structure main body (1) is a large grid rigid frame, which is used for protecting an internal liquid balloon structure (2) in the process of carbon dioxide submarine storage; the material of the frame structure main body (1) can be concrete or cast iron, and the shape can be square or spherical; the connecting device (3) is connected with the frame structure main body (1) and is used for connecting with a surface platform, to control the suspension and lifting of the liquid balloon device (6);
the liquid balloon structure (2) is used for storing the liquid carbon dioxide, and the liquid balloon structure (2) is connected with the frame structure main body (1) and is arranged in the rigid frame structure main body (1); the liquid balloon structure (2) is of flexible materials; a liquid balloon inlet pipe (4) and a stop valve (5) are arranged at an inlet of the liquid balloon structure (2), wherein the liquid balloon inlet pipe (4) is connected with the liquid carbon dioxide conveying pipe (9) through the stop valve (5) and is used for charging the liquid carbon dioxide into the liquid balloon structure (2), and the stop valve (5) is used for controlling the storage of the liquid carbon dioxide after the charging of the liquid carbon dioxide; before filling with liquid carbon dioxide, there is no filling inside the liquid balloon structure (2), and the liquid balloon structure (2) is in the contracted state; after filling with liquid carbon dioxide, the liquid balloon structure (2) is in an inflated state, and at this moment, the shape and size of the liquid balloon (2) are matched with that of the frame structure main body (1);
an outer side of the liquid balloon structure (2) is in direct contact with seawater; and in seawater at a depth of not less than 600 m, the carbon dioxide will remain liquid when being charged into the liquid balloon structure (2); and the structure of the liquid balloon (2) is flexible and an outer surface of the liquid balloon structure (2) is in direct contact with the seawater, so as to ensure that internal and external pressure differences of the liquid balloon structure (2) are only used to overcome elastic contraction force of the liquid balloon structure (2) and do not change with the depth of the seawater when the carbon dioxide is stored in the seabed, and the liquid balloon structure (2) will not be damaged due to excessive seawater pressure.

2. The carbon dioxide ocean liquid balloon storage method of claim 1, wherein the overall density of the liquid balloon device (6) is greater than that of seawater and the overall device has negative buoyancy in seawater. The relaxation speed of the suspended steel cable (11) is controlled, the suspended liquid balloon device (6) is placed in the seabed at the appropriate depth, and the connecting device (3) on the surface of the frame structure is disconnected to recycle the steel cable (11).

3. The carbon dioxide ocean liquid balloon storage method of claim 1, wherein in step 3, the submarine depth is not less than 3,000 m, at this depth, the density of the liquid carbon dioxide is greater than that of surrounding seawater, and the liquid balloon device can be stable in the seabed.

4. The carbon dioxide ocean liquid balloon storage method of claim 1, wherein in step 3, the liquid carbon dioxide is conveyed to the liquid balloon structure through the liquid carbon dioxide conveying pipe and the liquid balloon inlet pipe in the following ways: the liquid carbon dioxide from the surface platform (7) is charged into the liquid carbon dioxide conveying pipe (9) through a metering pump (8), and the liquid carbon dioxide enters the liquid balloon structure (2) through the conveying pipe (9) and the liquid balloon inlet pipe (4).

5. The carbon dioxide ocean liquid balloon storage method of claim 2, wherein in step 3, the liquid carbon dioxide is conveyed to the liquid balloon structure through the liquid carbon dioxide conveying pipe and the liquid balloon inlet pipe in the following ways: the liquid carbon dioxide from the surface platform (7) is charged into the liquid carbon dioxide conveying pipe (9) through the metering pump (8), and the liquid carbon dioxide enters the liquid balloon structure (2) through the conveying pipe (9) and the liquid balloon inlet pipe (4).

6. The carbon dioxide ocean liquid balloon storage method of claim 1, further comprising pre-placing a ring retaining structure in the seabed; after the liquid balloon device (6) is placed in the ring retaining structure, opening the frame structure of the liquid balloon device (6); discharging the liquid balloon structure (2) into the ring retaining structure; and retracting and reusing the frame structure under the action of steel cables (11).

7. The carbon dioxide ocean liquid balloon storage method of claim 2, further comprising pre-placing the ring retaining structure in the seabed; after the liquid balloon device (6) is placed in the ring retaining structure, opening the frame structure of the liquid balloon device (6); discharging the liquid balloon structure (2) into the ring retaining structure; and retracting and reusing the frame structure under the action of steel cables (11).

8. The carbon dioxide ocean liquid balloon storage method of claim 3, further comprising pre-placing the ring retaining structure in the seabed; after the liquid balloon device (6) is placed in the ring retaining structure, opening the frame structure of the liquid balloon device (6); discharging the liquid balloon structure (2) into the ring retaining structure; and retracting and reusing the frame structure under the action of steel cables (11).

9. The carbon dioxide ocean liquid balloon storage method of claim 6, wherein the shape of the annular retaining structure is similar to a large open chamber, and can be a fence and wall structures for protecting and fixing the liquid balloon structure.

10. The carbon dioxide ocean liquid balloon storage method of claim 7, wherein the shape of the annular retaining structure is similar to a large open chamber, and can be a fence and wall structures for protecting and fixing the liquid balloon structure.
